(19) United States
(12) Patent Application Publication
(10) Pub. No.: US 2022/0290489 A1
(43) Pub. Date: Sep. 15, 2022

(54) BIFOLD DOOR FOR MOVEABLE WALL SYSTEM

(71) Applicant: HNI Technologies Inc., Muscaline, IA (US)

(72) Inventors: Matthew C. Brown, Wilton, IA (US); Jared Anderson, Muscatine, IA (US)

(21) Appl. No.: 17/690,846

(22) Filed: Mar. 9, 2022

Related U.S. Application Data
(60) Provisional application No. 63/158,758, filed on Mar. 9, 2021.

(51) Int. Cl. E06B 3/48; E06B 7/23

(52) U.S. Cl. CPC E06B 3/481; E06B 7/23

(57) ABSTRACT

Various aspects of the present disclosure are directed toward apparatuses, systems, and methods for use with a bifold door for a modular wall panel system. The bifold door may include sliding door hardware coupled to a top portion of the bifold door configured to translate the bifold door within the door frame; a first plurality of hinges spaced apart vertically; and a second plurality of hinges spaced apart vertically between a first leaf and a second leaf.

### CROSS REFERENCE TO RELATED APPLICATION

This application claims priority to Provisional Application No. 63/158,758 filed Mar. 9, 2021, which is herein incorporated by reference in its entirety.

### BACKGROUND

Fixed wall systems, moveable wall systems, and non-progressive wall systems are very well known in the art.

Some problems associated with fixed wall systems are the inability to displace and/or move the fixed wall systems once they are mounted. Fixed wall systems are also disadvantageous because their installation is quite lengthy. Some of the problems associated with moveable wall systems are that, very often, their components are over-engineered (e.g., too heavy), they require different and specialized tooling for assembly, and they generally comprise various different components which are not readily interchangeable. Some of the problems associated with non-progressive wall systems are the inability to independently change, move, and/or alter a particular component of the non-progressive wall system without affecting the other components operatively connected to the particular component.

Hence, in light of the aforementioned, there is a need for an improved system which, by virtue of its design and components, would be able to overcome or at least minimize some of the aforementioned prior art problems.

### SUMMARY

According to one example (“Example 1”) a bifold door for a modular wall panel system includes a first side portion configured to strike a portion of a door frame, a second side portion, a first leaf, a second leaf, a top portion extending between the first side portion and the second side portion; a sliding door hardware coupled to the top portion of the panel configured to translate the bifold door within the door frame; a first plurality of hinges spaced apart vertically along the second side portion; and a second plurality of hinges spaced apart vertically between the first leaf and the second leaf.

According to another example (“Example 2”), further to the bifold door of Example 1, the second plurality of hinges are configured to lessen a gap between the first leaf and the second leaf when the bifold door is in a closed configuration.

According to another example (“Example 3”), further to the bifold door of Example 1, the second plurality of hinges are configured to lessen acoustic transmission through the bifold door by lessening a gap between the first leaf and the second leaf.

According to another example (“Example 4”), further to the bifold door of Example 1, wherein the second plurality of hinges are configured to rotate the first leaf and the second leaf apart in transitioning between an open configuration and a closed configuration.

According to another example (“Example 5”), further to the bifold door of Example 1, the second plurality of hinges are arranged between the two first leaf and the second leaf when when the bifold door is in a closed configuration.

According to another example (“Example 6”), further to the bifold door of Example 1, the second plurality of hinges are hidden between the first leaf and the second leaf when viewed from at least one side of the bifold door in a closed configuration.

According to another example (“Example 7”), further to the bifold door of Example 1, the first plurality of hinges and the second plurality of hinges are configured to increase rigidity of the bifold door by stabilizing the bifold door.

According to another example (“Example 8”), further to the bifold door of Example 1, the first plurality of hinges and the second plurality of hinges are configured to lessen acoustic transmission through the bifold door by creating contact between the first leaf and the door frame.

According to another example (“Example 9”), further to the bifold door of Example 1, the sliding door hardware is coupled to the top portion adjacent to the first side portion.

According to another example (“Example 10”), further to the bifold door of Example 1, the sliding door hardware include a roller hardware configured to translate within the door frame.

According to another example (“Example 11”), further to the bifold door of Example 1, the sliding door hardware translates within a channel on the door frame.

According to another example (“Example 12”), further to the bifold door of Example 11, the channel includes a stop such that the sliding door hardware does not translate out of the channel.

According to another example (“Example 13”), further to the bifold door of Example 1, the first side portion includes a rounded edge.

According to another example (“Example 14”), further to the bifold door of Example 13, the rounded edge of the first side portion is configured to contact and rotate about a curved gasket arranged with the door frame.

According to one example (“Example 15”), a modular wall system includes a door frame for use with the modular wall panel system; a bifold door including a first side portion configured to strike a portion of a door frame, a second side portion, a first leaf, a second leaf, a top portion extending between the first side portion and the second side portion; a sliding door hardware coupled to the top portion of the panel configured to translate the bifold door within the door frame; a gasket arranged with the door frame configured to contact the first side portion in a closed configuration; a first plurality of hinges spaced apart vertically along the second side portion configured to facilitate contact between the second side portion and the door frame; and a second plurality of hinges spaced apart vertically between the first leaf and the second leaf configured to lessen a gap between the first leaf and the second leaf in the closed configuration and rotate the first leaf and the second leaf apart in transitioning between an open configuration and the closed configuration.

According to another example (“Example 16”), further to the system of Example 15, the second plurality of hinges are arranged to be hidden between the first leaf and the second leaf when viewed from at least one side of the bifold door in the closed configuration.

According to another example (“Example 17”), further to the bifold door of Example 15, the second plurality of hinges are configured to lessen acoustic transmission through the bifold door by lessening the gap between the first leaf and the second leaf.

According to another example (“Example 18”), further to the bifold door of Example 15, the first plurality of hinges and the second plurality of hinges are configured to increase rigidity of the bifold door by stabilizing the bifold door.

According to another example (“Example 19”), further to the bifold door of Example 15, the first plurality of hinges and the second plurality of hinges are configured to lessen acoustic transmission through the bifold door by creating contact between the first leaf and the door frame.

According to another example (“Example 20”), further to the bifold door of Example 15, the sliding door hardware is coupled to the top portion adjacent to the first side portion.

According to another example (“Example 21”), further to the bifold door of Example 15, the sliding door hardware include a roller hardware configured to translate within the door frame.

According to another example (“Example 22”), further to the bifold door of Example 15, the sliding door hardware translates within a channel on the door frame.

According to another example (“Example 23”), further to the bifold door of Example 22, the channel includes a stop such that the sliding door hardware does not translate out of the channel.

According to another example (“Example 24”), further to the bifold door of Example 15, the first side portion includes a rounded edge.

According to another example (“Example 25”), further to the bifold door of Example 24, the rounded edge of the first side portion is configured to contact and rotate about the gasket.

The foregoing Examples are just that and should not be read to limit or otherwise narrow the scope of any of the inventive concepts otherwise provided by the instant disclosure. While multiple examples are disclosed, still other embodiments will become apparent to those skilled in the art from the following detailed description, which shows and describes illustrative examples. Accordingly, the drawings and detailed description are to be regarded as illustrative in nature rather than restrictive in nature.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1 is a perspective view of an office space assembly having been assembled with a wall panel system, in accordance with various aspects of the present disclosure.

FIG. 2 is an example bifold door and door frame, in accordance with various aspects of the present disclosure.

FIG. 3A is a first view of an example bifold door in a partially open configuration, in accordance with various aspects of the present disclosure.

FIG. 3B is a second view of the example bifold door in a partially open configuration shown in FIG. 3A.

FIG. 4 is an example view of a portion of a bifold door and sliding door hardware, in accordance with various aspects of the present disclosure.

FIG. 5 is an example track of sliding door hardware, in accordance with various aspects of the present disclosure.

FIG. 6 is a view of a portion of an example bifold door, door frame, and gasket, in accordance with various aspects of the present disclosure.

### DETAILED DESCRIPTION

### Definitions and Terminology

This disclosure is not meant to be read in a restrictive manner. For example, the terminology used in the application should be read broadly in the context of the meaning those in the field would attribute such terminology.

With respect to terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error, differences in measurement and/or manufacturing equipment calibration, human error in reading and/or setting measurements, minor adjustments made to optimize performance and/or structural parameters in view of differences in measurements associated with other components, particular implementation scenarios, imprecise adjustment and/or manipulation of objects by a person or machine, and/or the like, for example. In the event it is determined that individuals having ordinary skill in the relevant arts would not readily ascertain values for such reasonably small differences, the terms “about” and “approximately” can be understood to mean plus or minus 10% of the stated value.

### Description of Various Embodiments

Persons skilled in the art will readily appreciate that various aspects of the present disclosure can be realized by any number of methods and apparatuses configured to perform the intended functions. It should also be noted that the accompanying drawing figures referred to herein are not necessarily drawn to scale but may be exaggerated to illustrate various aspects of the present disclosure, and in that regard, the drawing figures should not be construed as limiting.

Although the present invention as exemplified hereinafter was primarily designed for wall systems intended in work environments, for defining office spaces, etc., it could be used with other objects and for other purposes, as apparent to a person skilled in the art. For this reason, expressions such as “work”, “office”, “space”, “wall”, “panel” and any other references and/or other expressions equivalent thereto should not be taken as to limit the scope of the present invention and include all other objects and all other applications with which the present invention could be used and may be useful.

Moreover, in the context of the present invention, the expressions “system”, “kit”, “set”, “assembly”, “product” and “device”, as well as any other equivalent expressions and/or compounds word thereof known in the art will be used interchangeably, as apparent to a person skilled in the art. This applies also for any other mutually equivalent expressions, such as, for example: a) “mount”, “assemble”, “define”, “build”, “erect”, etc.; b) “wall”, “panel”, etc.; c) “office”, “work space”, “environment”, “structure”, “enclosure”, etc.; d) “rotating”, “driving”, “displacing”, “moving”, “supporting”, “conveying” etc.; e) “interchangeable”, “modular”, “progressive”, etc.; f) “enable”, “allow”, “permit”, etc.; g) “fastening”, “securing”, “attaching”, “anchoring”, “adjusting”, “positioning”, etc.; h) “hole”, “bore”, “slot”, “slit”, “groove”, “cavity”, etc.; i) “rotating”, “pivoting”, “turning”, “rolling”, etc.; j) “ceiling”, “upper, “top”, etc.; k) “floor”, “lower, “bottom”, etc.; k) “glass”, “laminate”, “panel”, “gypsum”, “board”, etc.; l) “positioning”, “spacing”, “locating”, “arranging”, “disposing”, etc.; m) “adjacent”, “neighboring”, “sequential”, etc.; n) “components”, “parts”, “elements”, etc.; as well as for any other mutually equivalent expressions, pertaining to the aforementioned expressions and/or to any other structural and/or functional aspects of the present invention, as also apparent to a person skilled in the art.

It will be considered that expressions such as “connected” and “connectable”, or “mounted” and “mountable”, may be interchangeable, in that the present invention also relates to a kit with corresponding components for assembling a resulting fully assembled office space.

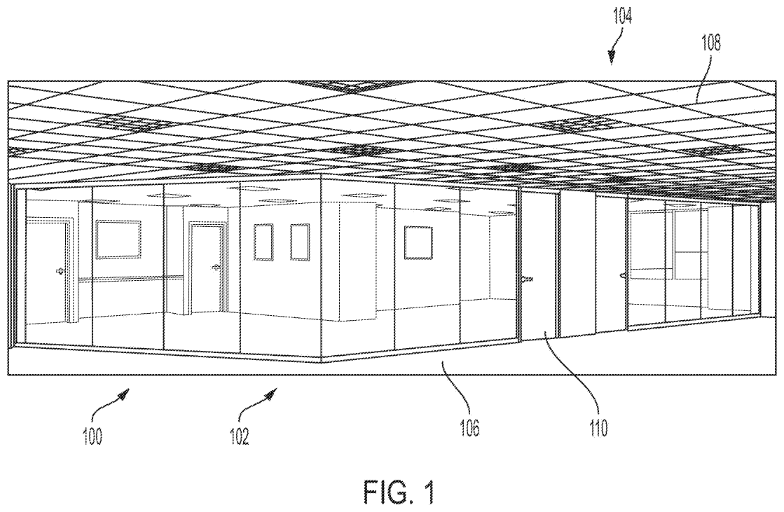

FIG. 1 is a perspective view of an office space assembly having been assembled with a modular wall panel system, in accordance with various aspects of the present disclosure. The modular wall panel system 100 may include a plurality of wall panels 102, which may be a frameless glass, and/or include solid wall and framed glass, or similar wall panels. Broadly described, the modular wall panel system 100 is a moveable and demountable system for defining a space 104, such as an office space as shown, with the plurality of wall panels 102. The wall panels 102 are disposable in a substantially upright manner between a floor 106 and a ceiling 108. As shown in FIG. 1, the modular wall panel system 100 may include a door or doors 110 arranged with the plurality of wall panels 102. One of more of the door or doors 110, in certain instances, may be a bifold door as shown as described below.

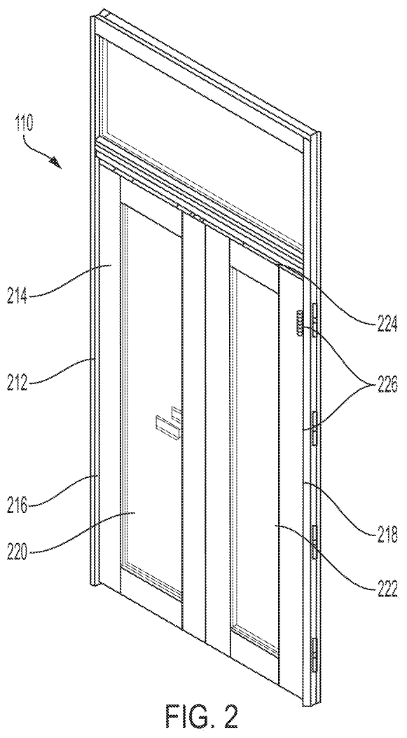

FIG. 2 is an example bifold door 110 and door frame 212, in accordance with various aspects of the present disclosure. The bifold door 110 may include a panel 214 including a first side portion 216 configured to strike a portion of a door frame 212, a second side portion 218, a first leaf 220, a second leaf 222, a top portion 224 extending across the two leaves 220, 222 between the first side portion 216 and the second side portion 218. In certain instances, and as described in further detail below, sliding door hardware may be coupled to the top portion 224 of the bifold door 110 configured to translate the bifold door 110 within the door frame 212.

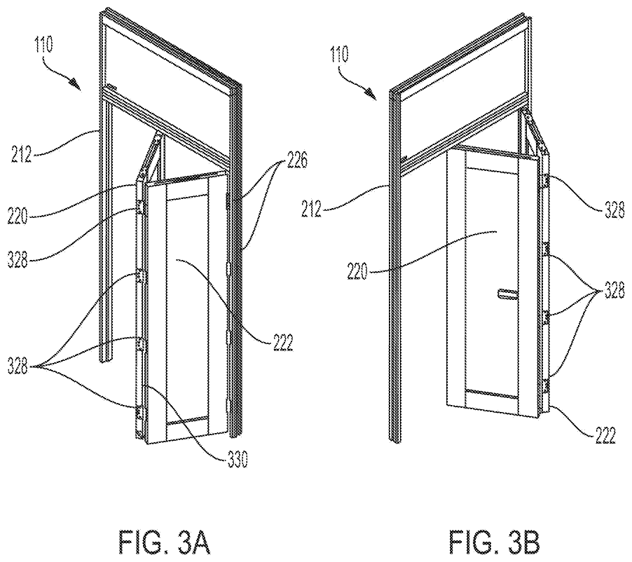

In certain instances, the bifold door 110 also includes a first plurality of hinges 226 spaced apart vertically along the second side portion 218. The first plurality of hinges 226 may be configured to facilitate pivoting of the bifold door 110 and more particularly the first leaf 220 when transitioning between a closed configuration (as shown in FIG. 2) and an open configuration (e.g., as shown in FIGS. 3A-3B). The first plurality of hinges 226 may also facilitate contact between the first leaf 220 and the door frame 212 in the closed configuration. Contact between the first leaf 220 and the door frame 212 may minimize acoustic transmission through the bifold door 110.

In certain instances, and as shown in further detail in FIGS. 3A-B, the bifold door 110 may also include a second plurality of hinges 328 spaced apart vertically between the two leaves 220, 222.

FIG. 3A is a first view of an example bifold door 110 in a partially open configuration, in accordance with various aspects of the present disclosure. FIG. 3B is a second view of the example bifold door 110 in a partially open configuration shown in FIG. 3A. As shown in FIGS. 3A-B, the bifold door 110 may include two leaves 220, 222. When transitioning between a closed configuration, as shown in FIG. 2, to an open configuration as shown in FIGS. 3A-3B, the leaves 220, 222 of the bifold door 110 may form a gap 330 therebetween.

The bifold door 110 may also include a second plurality of hinges 328 spaced apart vertically between the two leaves 220, 222. The second plurality of hinges 328 may span the gap 330 between the two leaves 220, 222. In certain instances, the second plurality of hinges 328 are configured to lessen the gap 300 between the leaves 220, 222 when the leaves 220, 222 are closed. If the bifold door 110 did not include the second plurality of hinges 328, a space between the leaves 220, 222 may be necessary to facilitate the hinging or folding open of the leaves 220, 222 when the bifold door 110 transitions to the open configuration. The second plurality of hinges 328 lessen the space necessary between the leaves 220, 222. In certain instances, the second plurality of hinges 328 are configured to lessen acoustic transmission through the bifold door 110 by lessening the space between the leaves 220, 222. The second plurality of hinges 328 are configured to rotate the leaves 220, 222 apart in transitioning between open and closed configurations.

In certain instances, the second plurality of hinges 328 are arranged between the two leaves 220, 222 when the bifold door 110 is closed. In certain instances, the first plurality of hinges 226 and the second plurality of hinges 328 are configured to increase rigidity of the bifold door 110. The first plurality of hinges 226 and the second plurality of hinges 238 may stabilize the bifold door 110 within a door frame 212. In certain instances, the first plurality of hinges 226 and the second plurality of hinges 328 may lessen the acoustic transmission through the bifold door 110 by stabilization of the bifold door 110 within the door frame 212.

As shown in comparing FIG. 2 and FIGS. 3A-3B, the second plurality of hinges 328 are hidden between the two leaves 220, 222 when viewed from at least one side of the bifold door 110 in the closed configuration. The second plurality of hinges 328 facilitate a lack of gap or a small gap between the leaves 220, 222 when the leaves 220, 222 are closed.

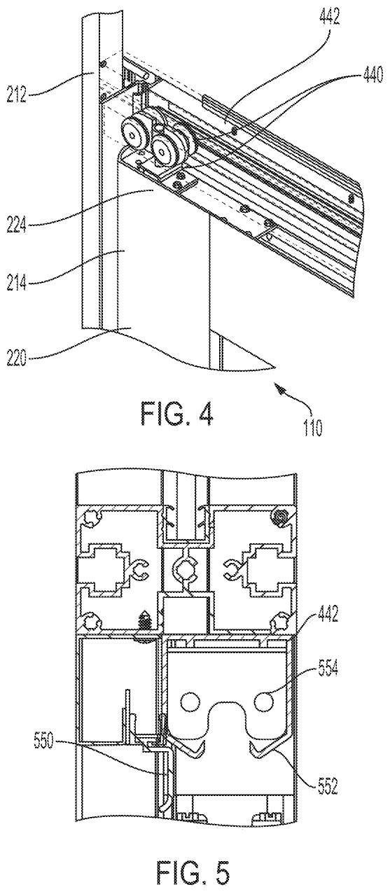

FIG. 4 is an example view of a portion of a bifold door 110 and sliding door hardware 440, in accordance with various aspects of the present disclosure. The sliding door hardware 440 (e.g., a roller or rollers) may be coupled or attached to a top portion 224 of the bifold door 110. The sliding door hardware 440 may include roller hardware configured to translate the panel within the door frame 212. The sliding door hardware 440 may be configured to slide or translate within a track 442, as shown in FIG. 5, that is coupled to the door frame 212.

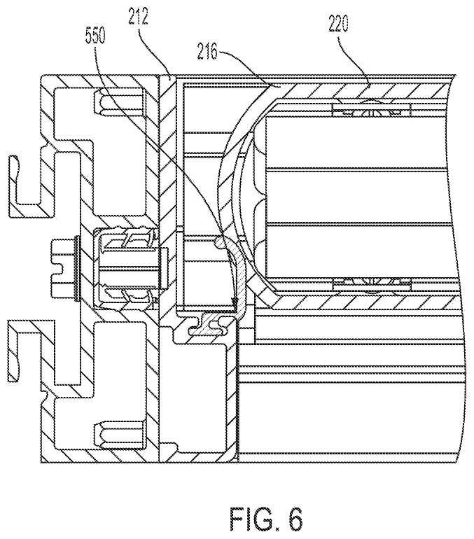

In certain instances, the sliding door hardware 440 may be attached to the bifold door 110 prior to mounting the bifold door 110 on the door frame 212. In certain instances, the sliding door hardware 440 is coupled to the top portion 224 adjacent to the first side portion 216 on a first leaf 220 of the two leaves 220, 222. As shown in FIG. 6 the first side portion 216 may include a rounded edge. The rounded edge of the first side portion 216 may be configured to rotate about a gasket 550 arranged with the door frame 212 as shown in FIG. 6. FIG. 6 also shows a view of the bifold door 110, the door frame 212, and the gasket 550, in accordance with various aspects of the present disclosure.

In certain instances, the gasket 550 may also include a curvature and extend toward a bottom from the door frame 212. In addition, the sliding door hardware 440 may translate within a channel 552. The channel 552 may include a stop 554 such that the sliding door hardware 440 does not translate out of the channel 552, as shown in FIG. 5.

The invention of this application has been described above both generically and with regard to specific embodiments. It will be apparent to those skilled in the art that various modifications and variations can be made in the embodiments without departing from the scope of the disclosure. Thus, it is intended that the embodiments cover the modifications and variations of this invention provided they come within the scope of the appended claims and their equivalents.

What is claimed is:

1. A bifold door for a modular wall panel system, the bifold door comprising:
a first side portion configured to strike a portion of a door frame, a second side portion, a first leaf, a second leaf, a top portion extending across the first leaf and the second leaf between the first side portion and the second side portion;
a sliding door hardware coupled to the top portion configured to translate the bifold door within the door frame;
a first plurality of hinges spaced apart vertically along the second side portion; and
a second plurality of hinges spaced apart vertically between the first leaf and the second leaf.

2. The bifold door of claim 1, wherein the second plurality of hinges are configured to lessen a gap between the first leaf and the second leaf when the bifold door is in a closed configuration.

3. The bifold door of claim 1, wherein the second plurality of hinges are configured to lessen acoustic transmission through the bifold door by lessening a gap between the first leaf and the second leaf.

4. The bifold door of claim 1, wherein the second plurality of hinges are configured to rotate the first leaf and the second leaf apart in transitioning between an open configuration and a closed configuration.

5. The bifold door of claim 1, wherein the second plurality of hinges are arranged between the first leaf and the second leaf when the bifold door is in a closed configuration.

6. The bifold door of claim 1, wherein the second plurality of hinges are hidden between the first leaf and the second leaf when viewed from at least one side of the bifold door in a closed configuration.

7. The bifold door of claim 1, wherein the first plurality of hinges and the second plurality of hinges are configured to increase rigidity of the bifold door by stabilizing the bifold door.

8. The bifold door of claim 1, wherein the first plurality of hinges and the second plurality of hinges are configured to lessen acoustic transmission through the bifold door by creating contact between the first leaf and the door frame.

9. The bifold door of claim 1, wherein the sliding door hardware is coupled to the top portion adjacent to the first side portion.

10. The bifold door of claim 1, wherein the sliding door hardware include a roller hardware configured to translate within the door frame.

11. The bifold door of claim 1, wherein the sliding door hardware translates within a channel on the door frame.

12. The bifold door of claim 11, wherein the channel includes a stop such that the sliding door hardware does not translate out of the channel.

13. The bifold door of claim 1, wherein the first side portion includes a rounded edge.

14. The bifold door of claim 13, wherein the rounded edge of the first side portion is configured to contact and rotate about a curved gasket arranged with the door frame.

15. A modular wall panel system comprising:
a door frame for use with the modular wall panel system;
a bifold door including a first side portion configured to strike a portion of the door frame, a second side portion, a first leaf, a second leaf, a top portion extending across the first leaf and the second leaf between the first side portion and the second side portion;
a sliding door hardware coupled to the top portion of the panel configured to translate the bifold door within the door frame;
a gasket arranged with the door frame configured to contact the first side portion in a closed configuration;
a first plurality of hinges spaced apart vertically along the second side portion configured to facilitate contact between the second side portion and the door frame; and
a second plurality of hinges spaced apart vertically between the first leaf and the second leaf configured to lessen a gap between the first leaf and the second leaf in the closed configuration and rotate the first leaf and the second leaf apart in transitioning between an open configuration and the closed configuration.

16. The system of claim 15, wherein the second plurality of hinges are arranged to be hidden between the first leaf and the second leaf when viewed from at least one side of the bifold door in the closed configuration.

17. The bifold door of claim 15, wherein the second plurality of hinges are configured to lessen acoustic transmission through the bifold door by lessening the gap between the first leaf and the second leaf.

18. The bifold door of claim 15, wherein the first plurality of hinges and the second plurality of hinges are configured to increase rigidity of the bifold door by stabilizing the bifold door.

19. The bifold door of claim 15, wherein the first plurality of hinges and the second plurality of hinges are configured to lessen acoustic transmission through the bifold door by creating contact between the first leaf and the door frame.

20. The bifold door of claim 15, wherein the sliding door hardware is coupled to the top portion adjacent to the first side portion.

21. The bifold door of claim 15, wherein the sliding door hardware include a roller hardware configured to translate within the door frame.

22. The bifold door of claim 15, wherein the sliding door hardware translates within a channel on the door frame.

23. The bifold door of claim 22, wherein the channel includes a stop such that the sliding door hardware does not translate out of the channel.

24. The bifold door of claim 15, wherein the first side portion includes a rounded edge.

25. The bifold door of claim 24, wherein the rounded edge of the first side portion is configured to contact and rotate about the gasket.
